(19) United States
(12) Patent Application Publication
(10) Pub. No.: US 2002/0054655 A1
(43) Pub. Date: May 9, 2002

(54) Method and apparatus for reducing multipath distortion in a wirless LAN system

(75) Inventors: Robert Conrad Malkemes, Bricktown, NJ (US); Henry Sedwick Miller, Yardley, PA (US); Charles Reed JR., Yardley, PA (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 09/995,126

(22) Filed: Nov. 27, 2001

Related U.S. Application Data
(63) Continuation-in-part of application No. 09/776,078, filed on Feb. 2, 2001.
(60) Provisional application No. 60/206,133, filed on May 22, 2000.
(60) Provisional application No. 60/259,834, filed on Jan. 5, 2001.

(51) Int. Cl. H04L 1/02

(52) U.S. Cl. 375/347

(57) ABSTRACT

A spatial diversity combiner comprises a plurality of feed forward equalizers (FFEs), a decision feedback equalizer (DFE), and a tap control circuit. The plurality of FFEs receive spatially diverse replicas of an RF signal and optimally combine them. The DFE provides feedback for tap weight control and optimal equalization of the transmission channel. Symbol error is generated by a slicer circuit or by a maximum likelihood sequence estimation (MLSE) process.

### CROSS-REFERENCE TO RELATED APPLICATIONS

This application is a continuation-in-part of co-pending U.S. patent application Ser. No. 09/776,078, filed Feb. 2, 2001, which claims benefit of U.S. provisional patent applications Ser. No. 60/206,133, filed May 22, 2000, and Ser. No. 60/259,834, filed Jan. 5, 2001. Each of the aforementioned related patent applications is herein incorporated by reference.

### BACKGROUND OF THE INVENTION

1. Field of the Invention

The invention generally relates to equalizers and, more particularly, the invention relates to a method and apparatus for adaptive spatial equalization of a channel in a wireless local area network (LAN) system.

2. Description of the Related Art

In a radio frequency (RF) transmission channel, a transmitted signal experiences time dispersion due to a deviation in the channel frequency response from the ideal channel characteristics of a constant amplitude and linear phase (constant delay) response. These non-ideal channel characteristics mainly result from multipath distortion, that is, the transmitted signal can take more than one path in the transmission channel. If at least two paths have a time difference exceeding the distance between two symbols transmitted in succession, a symbol on one of these paths will interfere with a following symbol on another, shorter path. This can result in signal fade and intersymbol interference (ISI).

Consequently, to achieve optimal demodulation of an RF signal, an equalizer is required in the receiver system to compensate for the non-ideal channel characteristics by using adaptive filtering. By correcting the amplitude and phase response of the received signal, the equalizer minimizes the ISI of the received signal, thus improving the signal detection accuracy.

Non-ideal channel characteristics are particularly problematic during reception of RF signals transmitted by wireless local area networks (LANs). Transmitting an RF signal over a wireless LAN introduces additional random dynamics on the amplitude and phase response of the channel, due in part to the motion of the users. High Doppler frequency, flat and frequency selective fading, and shadowing are the most common dominant factors that decrease receiver performance.

Therefore, there exists a need in the art for a method and apparatus for reducing multipath distortion in a wireless LAN transmission channel.

### SUMMARY OF THE INVENTION

The disadvantages associated with the prior art are overcome by a method and apparatus for reducing multipath distortion in an RF signal comprising a spatial diversity combiner. The spatial diversity combiner combats multipath distortion by gathering 2 or more spatially diverse replicas of an RF signal and combining them in an optimal way using a plurality of feed forward equalizers. The spatial combiner also simultaneously performs temporal equalization to reduce or eliminate inter-symbol interference via a decision feedback equalization process. The spatial diversity combiner of the present invention can equalize a dynamically changing channel of the type experienced in high data rate wireless LANs.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of a receiver having a spatial diversity combiner of the present invention;

FIG. 2 depicts a detailed block diagram of one embodiment of the spatial diversity combiner;

FIG. 3 depicts a detailed block diagram of a second embodiment of the spatial diversity combiner;

FIG. 4 depicts a system for executing a software implementation of the spatial diversity combiner; and

FIG. 5 depicts a block diagram of a receiver that employs a chipset to implement the spatial diversity combiner of the present invention.

### DETAILED DESCRIPTION OF THE PREFERRED EMBODIMENT

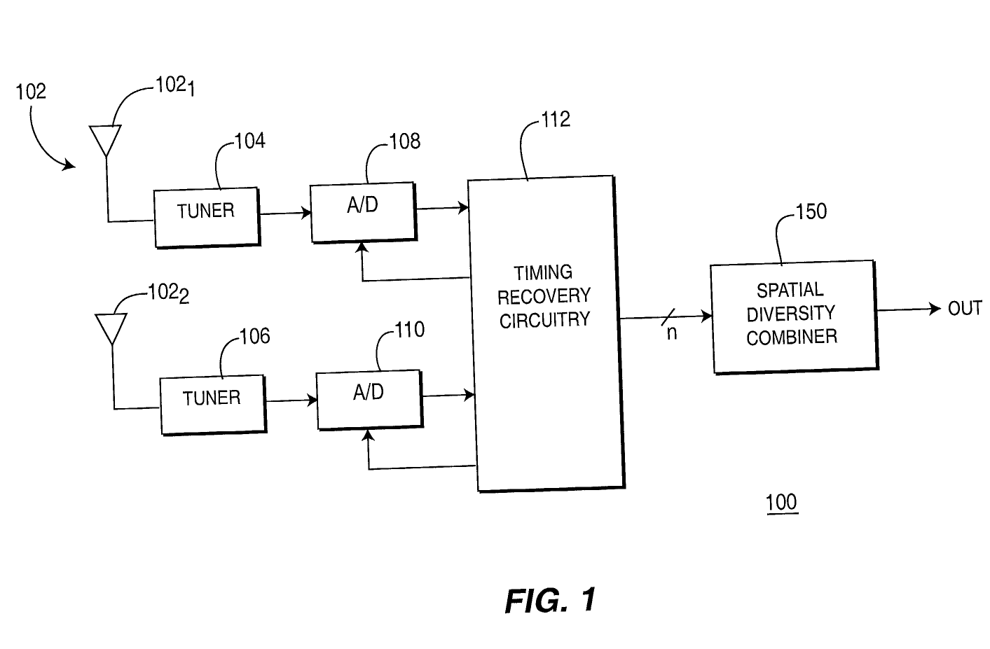

FIG. 1 depicts a block diagram of a receiver 100 that uses a spatial diversity combiner 150 to combat multipath distortion. In the present embodiment of the invention, the receiver is capable of receiving RF signals in the 5 GHz wireless band. The 5 GHz wireless band is the typical band used with short-range, high-speed wireless LANs used in home or office-like environments. The signal modulation used in such a system is typically 64 and/or 256 QAM. The symbol rate is 5 megasymbols/second. Although the present invention is described for use with a 5 GHz wireless LAN, it is known to those skilled in the art that the present invention could be adapted for use in other frequency bands.

Antennas 102₁ and 102₂ (collectively antennas 102) receive spatially diverse replicas of an RF signal transmitted, for example, over a 5 GHz wireless LAN. Although the present invention is described using two antennas, it is known by those skilled in the art that N antennas can be used. Each antenna 102₁ and 102₂ is respectively coupled to tuners 104 and 106. The tuners 104 and 106 filter and downconvert the received signal to near baseband. The near baseband signals are respectively coupled to the analog-to-digital (A/D) converters 108 and 110. The digitized signals are applied to the joint timing recovery circuitry 112. The timing recovery circuitry 112 generates, a signal at the symbol rate fs and synchronizes this signal to the best estimate of the transmitted data and then identifies symbol timing information for decoding and synchronization purposes.

The samples are then coupled to the spatial diversity combiner 150. The most difficult class of problems associated with this 5 GHz band is that of multipath. In this frequency band and in a home or SOHO environment, the multipath takes on a broad range of characteristics including frequency flat fading, frequency selective fading and Doppler distortion. To combat this set of problems, a multiple antenna diversity technique is used to form a spatial diversity equalizer/combiner. At least two antenna inputs are equalized and combined to reduce the effects of multipath encountered in the home or home/office environments.

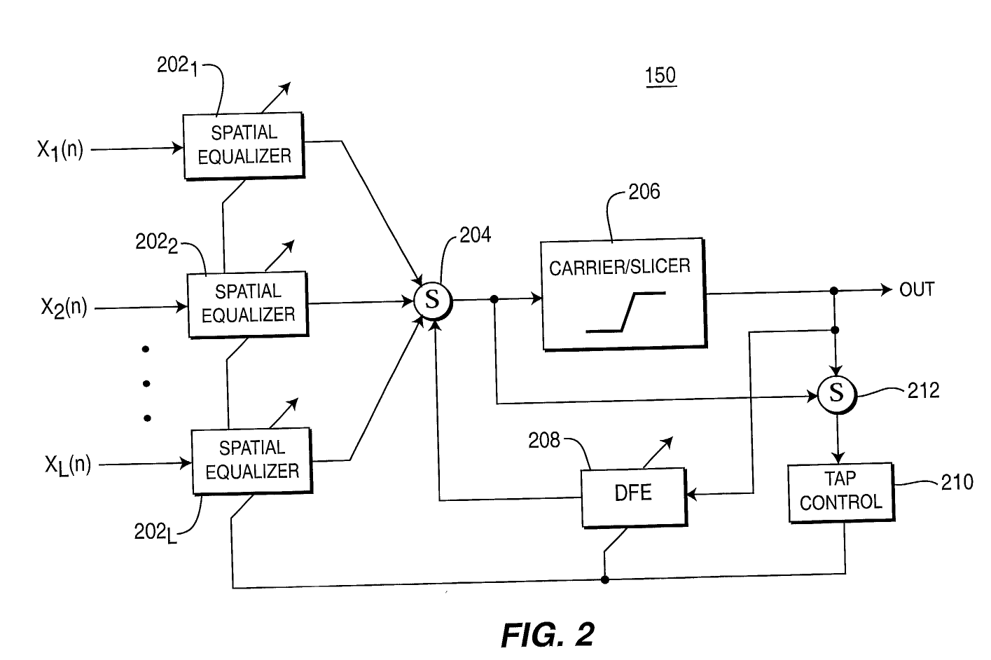

FIG. 2 depicts a detailed block diagram of an embodiment of the spatial diversity combiner 150. The spatial diversity combiner 150 comprises a plurality of spatial equalizers 202. These equalizers are multi-tap feed forward equalizers (FFEs) that delay their respective signals to achieve equal delays in the received signals on a symbol spaced basis. Once spatially equalized by equalizers 202, the signals are combined in combiner 204. The output of the combiner 204 is coupled to a single circuit 206 comprising both carrier loop recovery circuit and a slicer.

The carrier/slicer circuit 206 comprises a carrier recovery loop that extracts the carrier from the equalized symbols and a slicer circuit that samples the symbols to generate estimated symbols. The carrier recovery loop is used to correct for any frequency or phase offset in the received signal, thus mitigating some of the Doppler effects. The output of the carrier/slicer circuit 206 is coupled to the DFE 208 for temporal equalization and the removal of intersymbol interference. The output of the DFE 208 is coupled back to the combiner 204. The slicer in the carrier/slicer circuit 206 and subtractor 212 are used to produce a symbol error that is coupled to the tap control 210, that is, the slicer together with the subtractor 212 compares the estimated symbol sample with the closes known symbol and generates an error signal. The tap control 210 uses the error signal to produce tap weight adjustments for all the equalizers: the spatial equalizers 202₁-202_{L} and the DFE 208. The operation of the tap control 210 is discussed below.

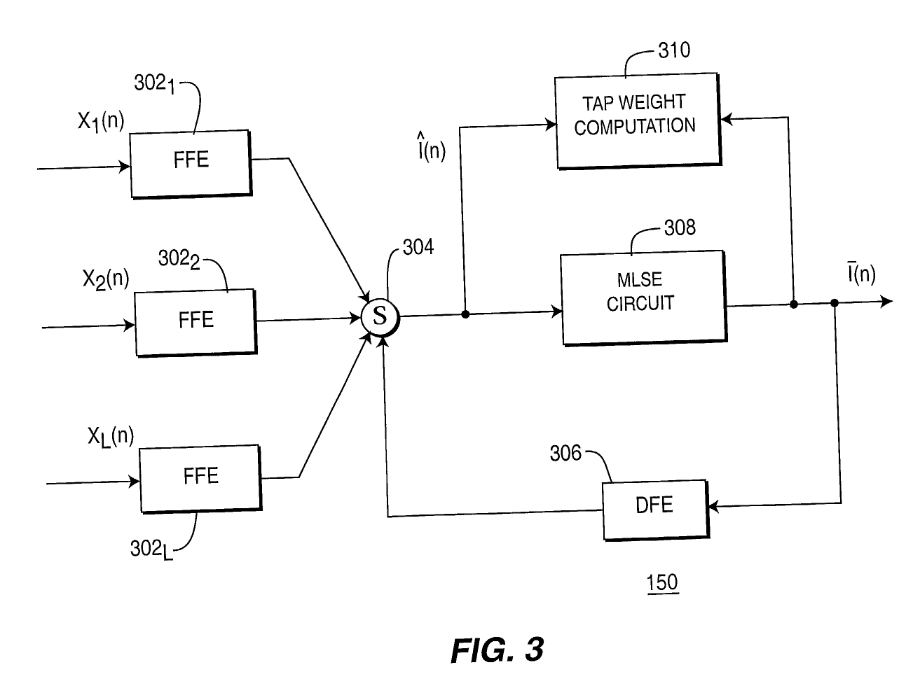

FIG. 3 depicts a block diagram of a second embodiment of the spatial diversity combiner 150. In the second embodiment, the spatial diversity combiner 150 comprises N feed forward equalizers 302, a combiner 304, a DFE 306, a maximum likelihood sequence estimation (MLSE) circuit 308, and a tap control circuit 310. Each of the FFE equalizers 302 receives a spatially diverse replica of the transmitted RF signal in sampled, near-baseband form. The number of taps included within each FFE 302 is determined by the maximum length of delay encountered by the replicas of the RF signal that are simultaneously received. The total length of each FFE 302 must span the entire length of the multipath signals (i.e., the spatially diverse replicas of the RF signal).

The output of each FFE 302 comprises an appropriately delayed replica of the RF signal. The combiner 304 combines each delayed replica with the output of the DFE 306. The output of the combiner 304 is coupled to the MLSE circuit 308 and to the tap control circuit 310. The tap control circuit 310 uses both the output of the combiner 304 and the output of the MLSE circuit 308 to compute the taps of the FFEs 302 and the DFE 306.

The MLSE circuit 308 makes an improved estimate of the output symbol decision based upon knowledge of the channel coding used. Maximum Likelihood Sequence Estimation, or MLSE, is used to improve the prediction of received symbols by including the trellis, or Viterbi, decoding operation before the DFE 306. The added complexity of this additional circuitry is warranted by the improvement in bit error rate (BER) and improved carrier-to-interference performance for the spatial diversity combiner 150. The level of performance is generally on the order of a few dB in BER performance. A convolution code is used in this system as the inner code making it appropriate for MLSE.

Referring to both FIGS. 2 and 3, the spatial diversity combiner 150 performs blind equalization and, thus, does not require a training sequence embedded in the RF signal to aid in adjusting the taps. The general operation of the spatial diversity combiner 150 is governed by the following set of equations:

C_{f}(n+1)=C_{f}(n)+μ·ε(n)·X*(n) Eq. 1

C_{b}(n+1)=C_{b}(n)+μ·ε(n)·I*(n) Eq. 2

where C_{f}(n) is the tap weight matrix for the FFE 202 or 302, X*(n) is the input signal matrix for the L input FFEs, and C_{b}(n) is the vector feedback tap weights for the DFE 208 or 306. The symbol ensemble of all possible symbols is given by I(n). As shown in FIGS. 2 and 3, the output of the combiner 204 or 304 is the symbol ensemble estimates Î(n). Given the symbol ensemble estimates, the error ε(n)=I(n)−Î(n) is derived and used to adjust the taps in accordance with Equations 1 and 2. The calculations are performed on a stepwise basis quantified by the value μ. A lower overall symbol error rate (SER) can be achieved with a smaller step size. A larger step size, however, will enable a faster convergence rate. For dynamically changing systems, such as a high-speed wireless LAN system, it is desirable to use adaptive step size techniques and optimal cost functions to achieve quick convergence while maintaining a low SER.

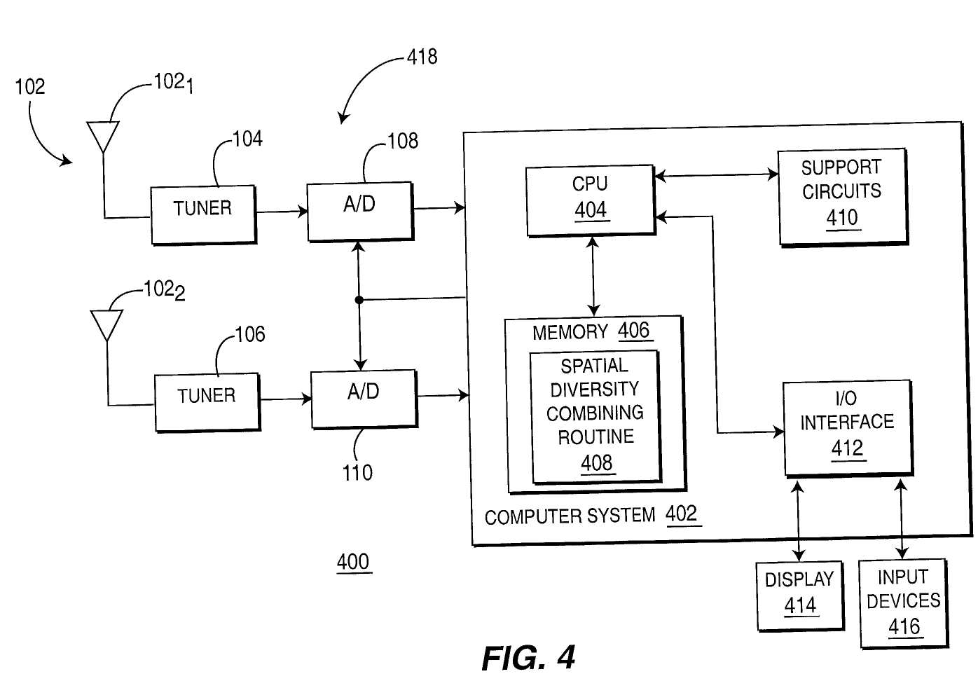

FIG. 4 depicts a system 400 for implementing the receiver 100 of the present invention. Elements in FIG. 4 that are similar to those illustrated in FIG. 1 are designated by the same reference number, and are described in detail above. The system 400 comprises a front end 418 and a computer system 402 that executes a spatial diversity combining routine 408. The front end 418 receives spatially diverse replicas of a transmitted RF signal and downconverts each replica to generate digitized near baseband signals. The front end 418 is illustratively shown as comprising tuners 104 and 106 and A/D converters 108 and 110. Antennas 102 provide input signals to the tuners 104 and 106. Although the present invention is shown as using two antennas, those skilled in the art will appreciate that N antennas can be used. The digitized near baseband signals are coupled to the computer system 402 for timing recovery and equalization using a spatial diversity process.

The computer system 402 comprises a central processing unit (CPU) 404, a memory 406, support circuits 410, and an input/output (I/O) interface 412. The computer system 402 may be a general purpose computer that is generally coupled through the I/O interface 412 to a display 414 and various input devices 416 such as a mouse and keyboard. Alternatively, the computer system 402 may be a specific purpose computer that is designed to process the received signals without the need for external input/output devices. The support circuits 410 generally contain well-known circuits such as cache, power supplies, clock circuits, a communications bus, and the like. The memory 406 may include random access memory (RAM), read only memory (ROM), disk drive, tape drive, and the like, or some combination of memory devices. The invention is implemented as the spatial diversity combining routine 408 that is stored in memory 406 and executed by the CPU 404 to process the signals from the front end 418. As such, the computer system 402 is a general purpose computer system that becomes a specific purpose computer system when executing the routine 408 of the present invention.

The spatial diversity combining routine 408 comprises a software implementation of the spatial diversity combiner 150. In one embodiment, the routine 408 performs equalization and spatial combining as described above with regard to FIG. 2. Alternatively, the routine 408 can perform spatial combining using an MLSE process as described above with regard to FIG. 3. As such, routine 408 performs the function associated with each block in the block diagrams of FIG. 2 and FIG. 3.

Although a general purpose computer system is illustratively shown as a platform for implementing the invention, those skilled in the art will realize that the invention can also be implemented in hardware as an application specific integrated circuit (ASIC), a digital signal processor (DSP) integrated circuit, or other hardware device or devices. As such, the invention may be implemented in software, hardware, or a combination of software and hardware.

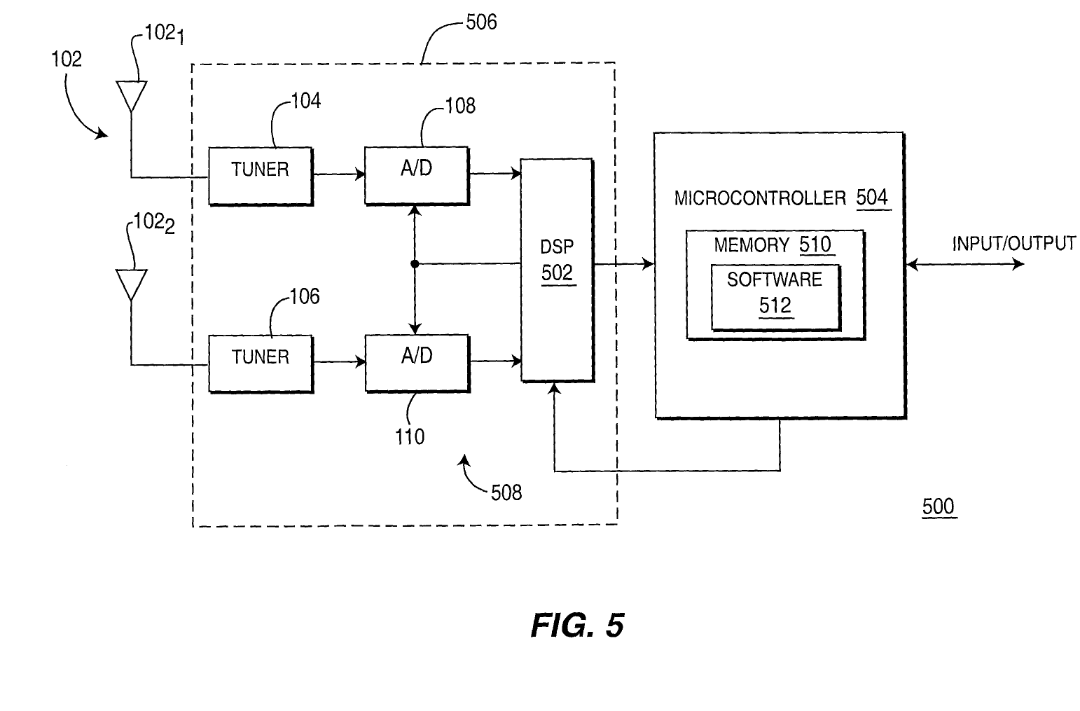

FIG. 5 depicts a block diagram of a chipset 500 for implementing the receiver 100 of the present invention. Elements in FIG. 5 that are similar to those illustrated in FIG. 1 are designated by the same reference number, and are described in detail above. In one embodiment, the chipset 500 comprises one or more integrated circuits, for example, a DSP 502 and a microcontroller 504. A front end 508 receives spatially diverse replicas of a transmitted RF signal and downconverts each replica to generate digitized near baseband signals. The front end 508 is illustratively shown as comprising tuners 104 and 106 and A/D converters 108 and 110. Antennas 102 provide input signals to the tuners 104 and 106. Although only two antennas are shown, those skilled in the art will appreciate that N antennas can be used.

The digitized near baseband signals from the front end 508 are coupled to the DSP 502 for timing recovery and equalization using the spatial diversity combining process of the present invention. In the present embodiment, the DSP 502 comprises a general purpose DSP. As understood by those skilled in the art, a general purpose DSP can include a reconfigurable array of processing elements that can perform multiple DSP operations such as timing recovery, equalization, and MLSE processing. The output of the DSP 502 is coupled to the microcontroller 504, which provides an equalized signal as output. In addition, the microcontroller 504 comprises memory 510 having software 512 for configuring the DSP 502 to implement the necessary DSP operations. For example, the microcontroller 504 can execute software 512 to cause the DSP 502 to implement the spatial diversity combiner 150 as shown in FIG. 2 or FIG. 3.

In an alternative embodiment, front end 508 and DSP 502 are implemented in a programmable ASIC 506. As understood by those skilled in the art, an ASIC comprises different functional blocks or function execution units in a single device. Such an ASIC can be implemented as, for example, a field programmable gate array (FPGA) device. In the present embodiment, programmable ASIC 506 comprises functional block equivalents of tuners 104 and 106, A/D converters 108 and 110, and DSP 502. The functional blocks of the programmable ASIC 506 are configured via microcontroller 504. Alternatively, ASIC 506 can comprise less than all of the functional blocks shown in FIG. 1. For example, tuners 104 and 106 can be implemented separately from the ASIC 506.

Although the chipset 500 has been described using a general purpose DSP or a programmable ASIC, those skilled in the art understand that either a specific purpose DSP or dedicated ASIC can also be used. Such embodiments could be implemented without microcontroller 504 and allow for a low-power configuration of chipset 500.

While foregoing is directed to the preferred embodiment of the present invention, other and further embodiments of the invention may be devised without departing from the basic scope thereof, and the scope thereof is determined by the claims that follow.

1. A computer readable storage medium containing a program that, when executed upon a computer system, causes the a receiver to perform a method of receiving a radio frequency (RF) signal comprising:
receiving a plurality of spatially diverse replicas of the RF signal;
adaptively combining the plurality of spatially diverse replicas to generate an equalized RF signal.

2. The computer readable medium of claim 1 wherein the combining step comprises:
spatially equalizing each of the plurality of spatially diverse replicas;
combining the spatially equalized replicas to generate a combined signal;
generating a symbol error signal from the combined signal using a symbol slicer;
temporally equalizing the combined signal using a decision feedback equalizer; and
adapting the spatial equalizing and the temporal equalizing steps to the symbol error signal.

3. The computer readable medium of claim 1 wherein the combining step comprises:
spatially equalizing each of the plurality of spatially diverse replicas;
combining the spatially equalized replicas to generate a combined signal;
generating a symbol error signal from the combined signal using a maximum likelihood sequence estimation process;
temporally equalizing the combined signal using a decision feedback equalizer; and
adapting the spatial equalizing and the temporal equalizing steps to the symbol error signal.

4. An apparatus for receiving a radio frequency (RF) signal comprising:
a front end for receiving spatially diverse replicas of the RF signal, selecting the RF signal from a frequency band, and digitizing the selected RF signal; and
an integrated circuit comprising means for adaptively combining the spatially diverse replicas of the selected RF signal to generate an equalized RF signal.

5. The apparatus of claim 4 wherein the integrated circuit is an application specific integrated circuit (ASIC).

6. The apparatus of claim 4 wherein the means for adaptively combining comprises:
a plurality of feed forward equalizers;
a combiner for combining the output signals from each of the plurality of feed forward equalizers to form a combined signal;
a carrier/slicer circuit for extracting the carrier from the combined signal and generating a symbol error signal;
a decision feedback equalizer for suppressing inter-symbol interference in the combined signal; and
a tap control circuit for adjusting the tap weights of the plurality of feed forward equalizers and the decision feedback equalizer using the symbol error signal.

7. The apparatus of claim 4 wherein the means for adaptively combining comprises:
a plurality of feed forward equalizers;
a combiner for combining the output signals from each of the plurality of feed forward equalizers to form a combined signal;
a maximum likelihood sequence estimation (MSLE) circuit for generating a symbol error signal from the combined signal;
a decision feedback equalizer for suppressing inter-symbol interference in the combined signal; and
a tap control circuit for adjusting the tap weights of the plurality of feed forward equalizers and the decision feedback equalizer using the symbol error signal.

8. The apparatus of claim 5 wherein the ASIC is a programmable ASIC and the apparatus further comprises a microcontroller for configuring the programmable ASIC to implement the means for adaptively combining the spatially diverse replicas of the RF signal to generate an equalized RF signal.

9. An apparatus for receiving a radio frequency (RF) signal comprising:
a front end for receiving spatially diverse replicas of the RF signal, selecting the RF signal from a frequency band, and digitizing the selected RF signal; and
a digital signal processor comprising means for adaptively combining the spatially diverse replicas of the RF signal to generate an equalized RF signal.

10. The apparatus of claim 9 wherein the means for adaptively combining comprises:
a plurality of feed forward equalizers;
a combiner for combining the output signals from each of the plurality of feed forward equalizers to form a combined signal;
a carrier/slicer circuit for extracting the carrier from the combined signal and generating a symbol error signal;
a decision feedback equalizer for suppressing inter-symbol interference in the combined signal; and
a tap control circuit for adjusting the tap weights of the plurality of feed forward equalizers and the decision feedback equalizer using the symbol error signal.

11. The apparatus of claim 9 wherein the means for adaptively combining comprises:
a plurality of feed forward equalizers;
a combiner for combining the output signals from each of the plurality of feed forward equalizers to form a combined signal;
a maximum likelihood sequence estimation (MSLE) circuit for generating a symbol error signal from the combined signal;
a decision feedback equalizer for suppressing inter-symbol interference in the combined signal; and
a tap control circuit for adjusting the tap weights of the plurality of feed forward equalizers and the decision feedback equalizer using the symbol error signal.

12. The apparatus of claim 9 wherein the DSP is a general purpose DSP and the apparatus further comprises a microcontroller for configuring the general purpose DSP to implement the means for adaptively combining the spatially diverse replicas of the RF signal to generate an equalized RF signal.

13. The apparatus of claim 9 wherein the tuners and the DSP are implemented as an application specific integrated circuit (ASIC).
